(19) United States
(12) Patent Application Publication
(10) Pub. No.: US 2024/0103334 A1
(43) Pub. Date: Mar. 28, 2024

(54) OPTICAL MODULE

(71) Applicant: SUMITOMO ELECTRIC INDUSTRIES, LTD., Osaka (JP)

(72) Inventors: Munetaka KUROKAWA, Osaka (JP); Tomoya SAEKI, Osaka (JP)

(21) Appl. No.: 18/467,009

(22) Filed: Sep. 14, 2023

(30) Foreign Application Priority Data
Sep. 26, 2022 (JP) 2022-152732
Apr. 19, 2023 (JP) 2023-068741

(51) Int. Cl. G02F 1/225; G02F 1/01; G02F 1/21

(52) U.S. Cl. CPC G02F 1/2257; G02F 1/0102; G02F 1/217; G02F 1/212; G02F 2203/21

(57) ABSTRACT

An optical module according to one embodiment includes: an optical element having a first side, a second side, and a third side; a housing; a thermoelectric cooler with the optical element being mounted on the thermoelectric cooler; a driving circuit arranged on the side of the first side of the optical element; a first bonding pad arranged on the side of the second side of the optical element; and a first wiring pattern provided on the frame body of the housing and connected to the first bonding pad of the optical element through the first bonding wiring, wherein the thermoelectric cooler has a plurality of Peltier elements arranged with spacings. A spacing between the plurality of Peltier elements located on the side of the second side is narrower than a spacing between the plurality of Peltier elements located in the center of the optical element.

### CROSS-REFERENCE TO RELATED APPLICATION

This application claims priority from Japanese Patent Application No. 2022-152732, filed on Sep. 26, 2022, and Japanese Patent Application No. 2023-068741, filed on Apr. 19, 2023, the entire subject matter of which is incorporated herein by reference.

### TECHNICAL FIELD

The present disclosure relates to optical modules.

### BACKGROUND

Japanese Unexamined Patent Publication No. 2021-174892 describes an optical transmission module. The optical transmission module has an optical modulation element optically coupled with an optical semiconductor laser element. The optical transmission module has a temperature control device including a substrate having a main surface and a back surface, a first mounting portion provided on the main surface of the substrate through a first temperature control element and mounting a semiconductor laser element, and a second mounting portion provided on the main surface of the substrate through a second temperature control unit and mounting the optical modulation element. Furthermore, the optical transmission module has a package including the semiconductor laser element, the optical modulation element, and the temperature control device and an intermediate block arranged between the first temperature control element and the second temperature control element and fixed to the main surface of the substrate.

### SUMMARY

An optical module according to the present disclosure includes: an optical element having a first side, a second side intersecting the first side, and a third side facing the second side; a housing accommodating the optical element; a thermoelectric cooler mounted inside the housing and with the optical element being mounted on the thermoelectric cooler; a driving circuit arranged on the side of the first side of the optical element; a first bonding pad arranged on the side of the second side of the optical element; and a first wiring pattern provided on the frame body of the housing and connected to the first bonding pad of the optical element through the first bonding wiring, wherein the thermoelectric cooler has a plurality of Peltier elements arranged with spacings. A spacing between the plurality of Peltier elements located on the side of the second side is narrower than a spacing between the plurality of Peltier elements located in the center of the optical element.

### BRIEF DESCRIPTION OF THE DRAWINGS

FIG. 1 is a partial cross-sectional view illustrating an internal structure of an optical module according to an embodiment.

FIG. 2 is a plan view illustrating an optical element of the optical module of FIG. 1.

FIG. 3 is a plan view schematically illustrating a thermoelectric cooler and a modulation element of the optical module of FIG. 1.

FIG. 4 is a graph illustrating temperature distributions in a width direction of an optical module according to a first embodiment and an optical module according to Comparative Example 1.

FIG. 5 is a graph different from FIG. 4 illustrating temperature distributions in the width direction of the optical module according to the first embodiment and the optical module according to Comparative Example 1.

FIG. 6 is a graph illustrating phase shifts of the optical module according to the first embodiment and the optical module according to Comparative Example 1.

FIG. 7 is a partial cross-sectional view illustrating an internal structure of an optical module according to Modified Example 1.

FIG. 8 is a plan view schematically illustrating a thermoelectric cooler and a modulation element of an optical module according to Modified Example 2.

FIG. 9 is a graph illustrating temperature distributions in a width direction of an optical module according to a second embodiment and an optical module according to Comparative Example 2.

FIG. 10 is a graph different from FIG. 9 illustrating temperature distributions in the width direction of the optical module according to the second embodiment and the optical module according to Comparative Example 2.

FIG. 11 is a graph illustrating phase shifts of the optical module according to the second embodiment and the optical module according to Comparative Example 2.

FIG. 12 is a plan view schematically illustrating a thermoelectric cooler and a modulation element of an optical module according to Modified Example 3.

FIG. 13 is a graph illustrating temperature distributions in a width direction of an optical module according to a third embodiment and the optical module according to Comparative Example 2.

FIG. 14 is a graph different from FIG. 13 illustrating the temperature distributions in the width direction of the optical module according to the third embodiment and the optical module according to Comparative Example 2.

FIG. 15 is a plan view schematically illustrating a thermoelectric cooler and a modulation element of an optical module according to Modified Example 4.

### DETAILED DESCRIPTION

By the way, in an optical module provided with a Mach-Zehnder (MZI) modulator, the Mach-Zehnder modulator performs phase adjustment by using a change in a refractive index due to an electro-optical effect such as a quantum confined Stark effect and a Pockels effect. The Mach-Zehnder modulator has two waveguides running parallel to each other. When the temperature distribution of these two waveguides becomes non-uniform, the optical path length between p and n may be changed, which causes a phase shift. Therefore, it is required to suppress the phase shift by allowing the temperature distribution to be nearly uniform.

An object of the present disclosure is to provide an optical module capable of suppressing a phase shift by allowing temperature distribution to be nearly uniform.

### DESCRIPTION OF EMBODIMENTS OF PRESENT DISCLOSURE

First, contents of embodiments of an optical module according to the present disclosure will be listed and described. An optical module according to one embodiment includes: (1) an optical element having a first side, a second side intersecting the first side, and a third side facing the second side; a housing accommodating the optical element; a thermoelectric cooler mounted inside the housing and with the optical element being mounted on the thermoelectric cooler; a driving circuit arranged on the side of the first side of the optical element; a first bonding pad arranged on the side of the second side of the optical element; and a first wiring pattern provided on the frame body of the housing and connected to the first bonding pad of the optical element through the first bonding wiring, wherein the thermoelectric cooler has a plurality of Peltier elements arranged with spacings. A spacing between the plurality of Peltier elements located on the side of the second side is narrower than a spacing between the plurality of Peltier elements located in the center of the optical element.

In this optical module, an optical element is mounted on the thermoelectric cooler. The optical element and the thermoelectric cooler are accommodated in the housing. The optical element has the second side and the third side facing the second side. The first bonding pad is arranged on the side of the second side of the optical element. The frame body of the housing has the first wiring pattern connected to the first bonding pads of the optical element through the first bonding wirings. Since the first bonding pads and the first bonding wirings are provided on the side of the second side, the heat inflow/outflow is likely to occur on the side of the second side compared to the center of the optical element. In this optical module, the plurality of Peltier elements are arranged with spacings in the thermoelectric cooler, and the spacing between the plurality of Peltier elements located on the side of the second side is narrower than the spacing of the plurality of Peltier elements located at the center of the optical element. Therefore, since the Peltier elements are densely arranged on the side of the second side compared to the center of the optical element, the influence of the heat inflow/outflow on the side of the second side can be reduced. Therefore, it is possible to allow the temperature distribution of the optical element to be nearly uniform and suppress the phase shift.

(2) In (1) above, the optical element may be a multimode interferometer having a first optical waveguide with a first signal light propagating in the first optical waveguide and a second optical waveguide with a second signal light different from the first signal light propagating in the second optical waveguide. The first optical waveguide may be provided closer to the side of the second side than the center of the multimode interferometer, and, the second optical waveguide may be provided closer to the side of the third side than the center of the multimode interferometer. In this case, the temperature of the first optical waveguide located on the side of the second side and the temperature of the second optical waveguide located on the side of the third side can be allowed to be nearly uniform.

(3) In (1) or (2) above, the optical module may include: a second bonding pad arranged on the side of the third side of the optical element; and a second wiring pattern provided on the frame body of the housing and connected to the second bonding pad of the optical element through the second bonding wiring. The spacing between the plurality of Peltier elements located on the side of the third side may be narrower than the spacing between the plurality of Peltier elements located in the center of the optical element. In this case, since the second bonding pad and the second bonding wiring are provided on the side of the third side, the heat inflow/outflow on the side of the third side is likely to occur compared to the center of the optical element. In this optical module, the spacing between the plurality of Peltier elements located on the side of the third side is narrower than the spacing between the plurality of Peltier elements located in the center of the optical element. Therefore, since the Peltier elements are densely arranged on the side of the third side compared to the center of the optical element, the influence of the heat inflow/outflow on the side of the third side can be reduced. Therefore, it is possible to allow the temperature distribution of the optical element to be nearly uniform and suppress the phase shift.

(4) In any one of (1) to (3) above, the optical module may include: a third bonding pad arranged on the side of the first side of the optical element; and a third wiring pattern provided in the driving circuit and connected to the third bonding pad of the optical element through a third bonding wiring. The spacing between the plurality of Peltier elements located on the side of the first side may be narrower than the spacing between the plurality of Peltier elements located in the center of the optical element. In this case, since the third bonding pad and the third bonding wiring are provided on the side of the first side, heat inflow/outflow on the side of the first side is likely to occur compared to the center of the optical element. In this optical module, the spacing between the plurality of Peltier elements located on the side of the first side is narrower than the spacing between the plurality of Peltier elements located in the center of the optical element. Therefore, since the Peltier elements are densely arranged on the side of the first side compared to the center of the optical element, the influence of the heat inflow/outflow on the side of the first side can be reduced. Therefore, it is possible to allow the temperature distribution of the optical element to be nearly uniform and suppress the phase shift.

(5) In (4) above, the driving circuit may be a heating element. The driving circuit is arranged on the side of the first side of the optical element. In this optical module, as described above, the Peltier elements are densely arranged on the side of the first side of the optical element where the driving circuit is arranged. Therefore, since the influence of the heat inflow/outflow from the driving circuit can be reduced, the temperature distribution of the optical element can be allowed to be nearly uniform, and thus, the phase shift can be suppressed.

An optical module according to another embodiment includes: (6) an optical element having a first side, a second side intersecting the first side, and a third side facing the second side; a housing accommodating the optical element; a thermoelectric cooler disposed inside the housing, with the optical element being mounted on the thermoelectric cooler; a first heat capacity portion located around the optical element; and a second heat capacity portion located around the optical element and at a position different from the first heat capacity portion. The heat capacity in the first heat capacity portion is larger than the heat capacity in the second heat capacity portion. The thermoelectric cooler has a plurality of Peltier elements arranged with spacings. The spacing between the plurality of Peltier elements located on the side of the first heat capacity portion is narrower than the spacing between the plurality of Peltier elements located on the side of the second heat capacity portion.

In this optical module, the optical element is mounted on the thermoelectric cooler, and the optical element and the thermoelectric cooler are accommodated in the housing. The optical element has the second side and the third side facing the second side. Around the optical element, the first heat capacity portion, and the second heat capacity portions located at the positions different from the first heat capacity portion are arranged. The heat capacity in the first heat capacity portion is larger than the heat capacity in the second heat capacity portion. Therefore, the heat inflow/outflow of the optical element in the first heat capacity portion is likely to occur compared to the second heat capacity portion. In this optical module, the plurality of Peltier elements are arranged with spacings in the thermoelectric cooler, and the spacing between the plurality of Peltier elements located on the first heat capacity portion side is narrower than the spacing between the plurality of Peltier elements located on the second heat capacity portion side. Therefore, since the Peltier elements are densely arranged on the first heat capacity portion side compared to the second heat capacity portion side, the influence of the heat inflow/outflow on the first heat capacity portion side can be reduced. Therefore, it is possible to allow the temperature distribution of the optical element to be nearly uniform and suppress the phase shift.

### DETAILS OF EMBODIMENT OF PRESENT DISCLOSURE

A specific example of the optical module according to the embodiment of the present disclosure will be described below with reference to the drawings. It is noted that the present invention is not limited to the following examples, but is intended to include all modifications indicated in the scope of claims and within the scope of equivalents to the scope of claims. In the description of the drawings, the same or corresponding components are denoted by the same reference numerals, and overlapping descriptions are omitted as appropriate. In addition, the drawings may be partially simplified or exaggerated for easy understanding, and the dimensional ratios and the like are not limited to those described in the drawings.

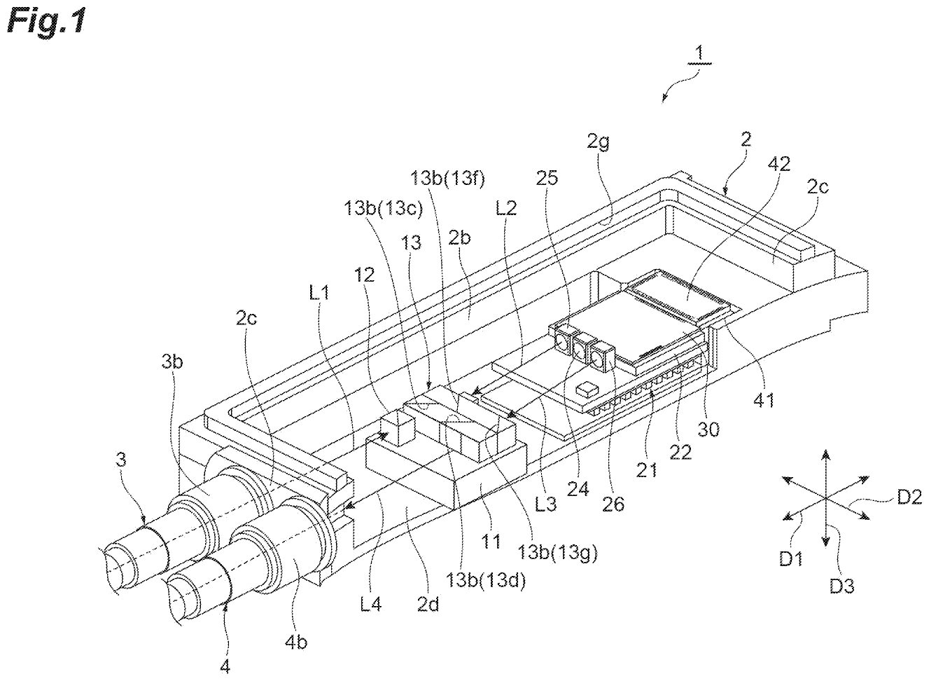

FIG. 1 is a partial cross-sectional view illustrating an internal structure of an optical module 1 as an example. As illustrated in FIG. 1, the optical module 1 includes a rectangular parallelepiped housing 2 and an input assembly 3 and an output assembly 4 extending from the housing 2. Each of the input assembly 3 and the output assembly 4 has a cylindrical shape. The housing 2 includes a first side wall 2b extending along a first direction D1, a pair of second side walls 2c extending along a second direction D2 intersecting the first direction D1, and a bottom wall 2d on which components of the optical module 1 are mounted. The first direction D1 is a longitudinal direction of the optical module 1, and the second direction D2 is a width direction of the optical module 1.

The first side wall 2b extends in both the first direction D1 and a third direction D3. The third direction D3 is the direction intersecting both the first direction D1 and the second direction D2 and corresponds to a height direction of the optical module 1. The pair of second side walls 2c are aligned along the first direction D1, and each second side wall 2c extends in both the second direction D2 and the third direction D3. The bottom wall 2d extends in both the first direction D1 and the second direction D2 at one end of the first side wall 2b and the second side wall 2c in the third direction D3. The pair of first side walls 2b and the pair of second side walls 2c constitute a frame body 2g of the housing 2 having the frame body shape when viewed from the third direction D3.

The input assembly 3 and the output assembly 4 extend along the first direction D1 from one of the pair of second side walls 2c. The input assembly 3 and the output assembly 4 are aligned along the second direction D2. The input assembly 3 is the portion that inputs an input light L1 from the outside of the optical module 1 to the inside of the optical module 1. The output assembly 4 is the portion that outputs an output light L4 from the inside of the optical module 1 to the outside of the optical module 1. Each of the input assembly 3 and the output assembly 4 has an embedded lens. The input assembly 3 has a lens holder 3b that holds the lens of the input assembly 3, and the output assembly 4 has a lens holder 4b that holds the lens of the output assembly 4.

The optical module 1 includes an optical base 11 mounted on the bottom wall 2d and a filter 12 and a composite filter block 13 mounted on an optical base 11. The filter 12 transmits the input light L1 from the input assembly 3. The filter 12 inputs the input light L1 to the composite filter block 13. The composite filter block 13 is located on the side opposite to the input assembly 3 when viewed from the filter 12. The composite filter block 13 has a plurality of reflective surfaces 13b that reflect the input light L1.

The plurality of reflective surfaces 13b include a first reflective surface 13c, a second reflective surface 13d, a third reflective surface 13f and a fourth reflective surface 13g. The first reflective surface 13c and the second reflective surface 13d are aligned along the second direction D2. The position of the third reflective surface 13f in the second direction D2 is shifted from the position of the first reflective surface 13c in the second direction D2 and the position of the second reflective surface 13d in the second direction D2. The position of the fourth reflective surface 13g in the second direction D2 is shifted from the position of the first reflective surface 13c in the second direction D2 and the position of the second reflective surface 13d in the second direction D2. The third reflective surface 13f and the fourth reflective surface 13g are aligned along the second direction D2.

The input light L1 incident on the composite filter block 13 along the first direction D1 from the filter 12 is reflected by the first reflective surface 13c in the second direction D2. The input light L1 reflected by the first reflective surface 13c is reflected by the second reflective surface 13d in the first direction D1 and emitted to the side opposite to the input assembly 3.

An output light L2 and an output light L3, which is to be described in detail later, are input to the composite filter block 13 from the side opposite to the output assembly 4 along the first direction D1. The output light L2 is reflected by the third reflective surface 13f in the second direction D2. The output light L2 reflected by the third reflective surface 13f is reflected by the fourth reflective surface 13g in the first direction D1. The output light L3 passes through the fourth reflective surface 13g. The composite filter block 13 emits the output light L2 and the output light L3 to the output assembly 4 as the output light L4. The output light L4 emitted to the output assembly 4 is output to the outside of the optical module 1.

The optical module 1 includes a temperature control device (thermoelectric cooler) 21 mounted on the bottom wall 2d, a modulation element carrier 22 mounted on the temperature control device 21, and a modulation element (optical element) 30 mounted on the modulation element carrier 22. The optical module 1 includes an input lens system 24, a first output lens system 25, and a second output lens system 26. The temperature control device 21 is the thermo electric cooler (TEC).

The modulation element 30 is, for example, a multimode interferometer in which the Mach-Zehnder interferometer is formed on the indium phosphide (InP) substrate. In addition, the modulation element 30 may be an element in which the optical waveguide is formed on an Si substrate. As an example, the modulation element 30 includes indium phosphide (InP), silicon dioxide (SiO₂), and benzocyclobutene (BCB). The temperature control device 21 and the modulation element will be described in detail later. The input lens system 24 is mounted between the modulation element 30 and the composite filter block 13. The first output lens system 25 and the second output lens system 26 are mounted on both sides of the input lens system 24 in the second direction D2.

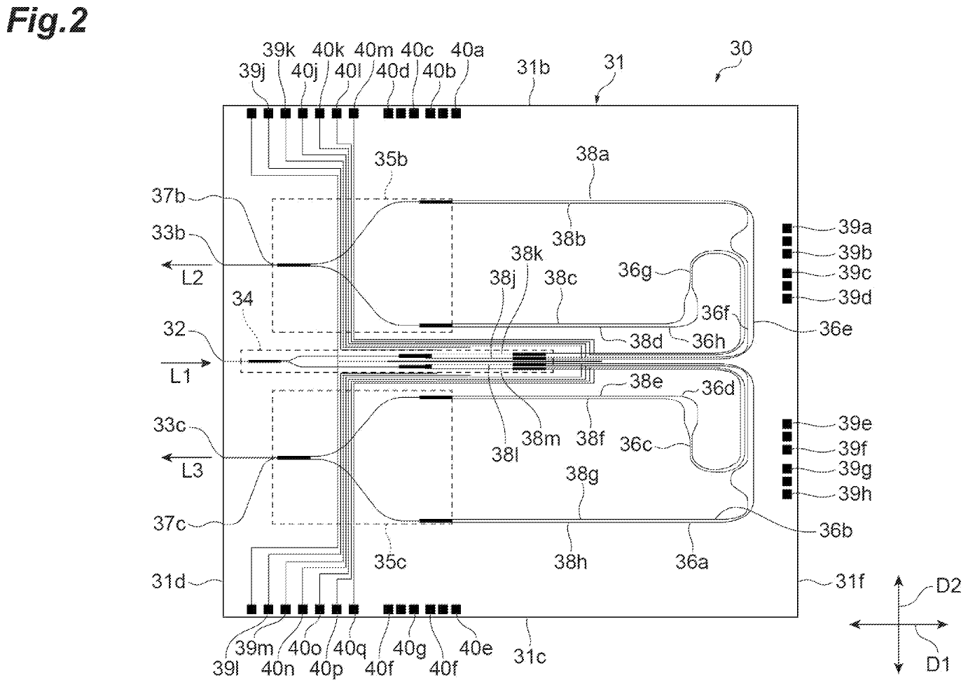

The optical module 1 includes a heat sink 41 located on the side opposite to the composite filter block 13 when viewed from the modulation element 30 and a driver IC (driving circuit) 42 mounted on the heat sink 41. FIG. 2 is a plan view illustrating the modulation element 30. The modulation element 30 is, for example, a multimode interferometer having a plurality of optical waveguides. As illustrated in FIG. 2, the modulation element 30 includes, for example, a modulator chip 31, an input port 32, a first output port 33b, a second output port 33c, a splitter 34, a first multiplexing portion 35b, a second multiplexing portion 35c, optical waveguides 36a to 36h, a first monitor port 37b, and a second monitor port 37c.

As illustrated in FIGS. 1 and 2, the planar shape of the modulator chip 31 is, for example, rectangular. The modulator chip 31 has sides 31b and 31c extending in the first direction D1 and sides 31d and 31f extending in the second direction D2. The input port 32 is an optical port through which the input light L1 output from the composite filter block 13 (second reflective surface 13d) is input through the input lens system 24. The input port 32 is located on the side 31d. For example, the input port 32 is located at the center of the side 31d in the second direction D2. The driver IC 42 is arranged on the side 31f (first side) of the modulation element 30.

The first output port 33b is an optical port for outputting the output light (first signal light) L2 to the first output lens system 25, and the second output port 33c is an optical port for outputting the output light (second signal light) L3 to the second output lens system 26. The output light L2 output from the first output port 33b passes through the first output lens system 25 to be incident on the composite filter block 13. The output light L3 output from the second output port 33c passes through the second output lens system 26 to be incident on the composite filter block 13. The first output port 33b and the second output port 33c are provided on the side 31d of the modulator chip 31. The first output port 33b and the second output port 33c are arranged at positions which are symmetrical with respect to the input port 32.

The splitter 34 splits the input light L1 input from the input port 32 into the optical waveguides 36a to 36h. The first multiplexing portion 35b multiplexes the signal lights (a portion of the plurality of signal lights) propagating through optical waveguides 36e to 36h to supply the multiplexed signal light as the output light L2 to the first output port 33b. The second multiplexing portion 35c multiplexes the signal lights (residues of the plurality of signal lights) propagating through optical waveguides 36a to 36d to supply the multiplexed signal light as the output light L3 to the second output port 33c.

The modulation element 30 has modulation electrodes 38a to 38h, parent phase adjustment electrodes 38j to 38m, and child phase adjustment electrodes (not illustrated). The modulation electrodes 38a to 38h are provided on the optical waveguides 36a to 36h, respectively. The modulation electrodes 38a to 38h apply modulated voltage signals to the optical waveguides 36a to 36h to change the refractive index of light passing through the optical waveguides 36a to 36h. Accordingly, the phase of light propagating through the optical waveguides 36a to 36h is modulated.

One end of each of the modulation electrodes 38a to 38h is electrically connected to each of RF pads 39a to 39h for the signal input through the wiring pattern, respectively. The RF pads 39a to 39h for the signal input are electrically connected to the driver IC 42. The other ends of the modulation electrodes 38a to 38h are electrically connected to signal pads 40a to 40h for signal termination through the wiring patterns, respectively. The parent phase adjustment electrodes 38j to 38m are electrically connected to bias pads 39j to 39m through the wiring patterns, respectively. The child phase adjustment electrodes are connected to respective bias pads 40j to 40q for adjustment signal input through the wiring patterns.

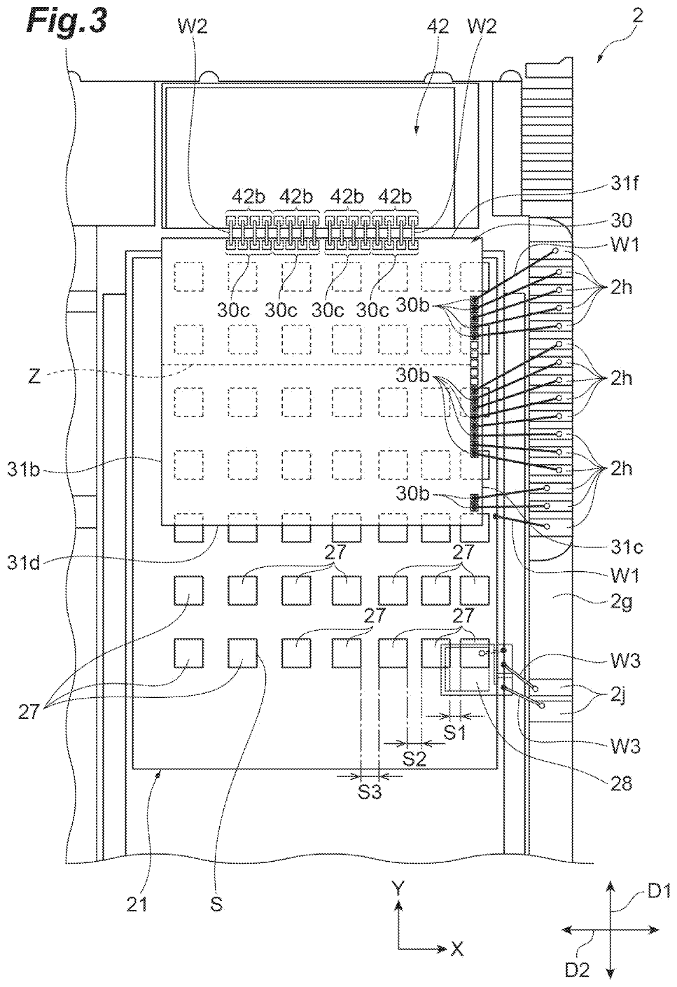

FIG. 3 is a plan view schematically illustrating the temperature control device 21, the modulation element 30, and the driver IC 42. As illustrated in FIG. 3, the driver IC 42 has electrode pads 42b. The electrode pads 42b are aligned along the second direction D2 at the end of the driver IC 42 on the modulation element 30 side. The optical module 1 has a wiring pattern (first wiring pattern) 2h provided on the frame body 2g of the housing 2. The wiring pattern 2h is aligned along the first direction D1 at the end of the housing 2 in the second direction D2. The modulation element 30 has an electrode pad 30c at the position facing the driver IC 42, and the electrode pads 30c are aligned along the second direction D2. The optical module 1 has bonding wirings W2 that electrically connect the electrode pads 30c and 42b to each other.

For example, the modulation element 30 has a control terminal (first bonding pad) 30b. The control terminals 30b are aligned along the first direction D1 on the side 31c (second side) side. The wiring pattern 2h is connected to the control terminal 30b of the modulation element 30 through a bonding wiring (first bonding wiring) W1. Furthermore, the optical module 1 has the thermistor 28. The thermistor 28 is arranged, for example, between the modulation element 30 and the composite filter block 13. The thermistor 28 is electrically connected to a pad 2j provided on the frame body 2g through a bonding wiring W3.

The temperature control device 21 has a plurality of Peltier elements 27. The plurality of Peltier elements 27 are arranged in the lattice shape to be aligned along the first direction D1 and to be aligned along the second direction D2. The plurality of Peltier elements 27 are arranged with spacings S. For example, the spacing S between two Peltier elements 27 aligned along the second direction D2 varies depending on the positions of the Peltier elements 27 in the second direction D2. The spacing S between the plurality of Peltier elements 27 located on the side 31c side (the control terminal 30b side of the modulation element 30 or the wiring pattern 2h side of the housing 2) is narrower than the spacing S between the plurality of Peltier elements 27 located on the side 31b side. That is, the plurality of Peltier elements 27 are densely arranged on the side 31c side compared to the side 31b side.

The spacing S between the plurality of Peltier elements 27 located on the side 31c side is narrower than the spacing S between the plurality of Peltier elements 27 located in the center of the modulation element 30. The center of the optical element (the modulation element 30) indicates the center of the optical element (the modulation element 30) when viewed from the third direction D3. For example, a spacing S1 between the Peltier element 27 located closest to the side 31c side and the Peltier element 27 located second closest to the side 31c side is narrower than a spacing S2 between the Peltier element 27 located second closest to the side 31c side and the Peltier element 27 located third closest to the side 31c side. The spacing S2 is narrower than a spacing S3 between the Peltier element 27 located third closest to the side 31c side and the Peltier element 27 located fourth closest to the side 31c side. As an example, the spacing S1 is 0.15 mm, the spacing S2 is 0.2 mm, and the spacing S3 is 0.25 mm. The spacing S between the plurality of Peltier elements 27 located in the center of the modulation element 30 may be the same as the spacing S3.

Next, functions and effects obtained from the optical module 1 according to this embodiment will be described. In the optical module 1, the modulation element 30 is mounted on the temperature control device 21. The modulation element 30 and the temperature control device 21 are accommodated in the housing 2. The modulation element has the side 31c and the side 31b facing the side 31c. The control terminal 30b is arranged as the first bonding pad on the side 31c side of the modulation element 30. The frame body 2g of the housing 2 has the wiring pattern 2h connected to the control terminal 30b of the modulation element 30 through the bonding wiring W1. Since the control terminal 30b and the bonding wiring W1 are provided on the side 31c side, in the side 31c side, the heat inflow/outflow is likely to occur compared to the side 31b side. In the optical module 1, the plurality of Peltier elements 27 are arranged with spacings S in the temperature control device 21, and the spacing S between the plurality of Peltier elements 27 located on the side 31c side is narrower than the spacing S between the plurality of Peltier elements 27 located on the side 31b side. Therefore, since the Peltier elements 27 are densely arranged on the side 31c side compared to the side 31b side, the influence of the heat inflow/outflow on the side 31c side can be reduced. Therefore, the temperature distribution of the modulation element 30 can be allowed to be nearly uniform, and thus, the phase shift can be suppressed.

That is, since the control terminal 30b and the bonding wiring W1 are provided on the side 31c side, in the side 31c side, the heat inflow/outflow is likely to occur compared to the center of the modulation element 30. In the optical module 1, the spacing S between the plurality of Peltier elements 27 located on the side 31c side is narrower than the spacing S between the plurality of Peltier elements 27 located in the center of the modulation element 30. Therefore, the Peltier elements 27 are densely arranged on the side 31c side compared to the center of the modulation element 30. Therefore, the influence of the heat inflow/outflow on the side 31c side can be reduced, and the temperature distribution of the modulation element 30 can be allowed to be nearly uniform, and thus, the phase shift can be suppressed.

As described above, the modulation element 30 may be a multimode interferometer including first optical waveguides 36e to 36h through which the output light L2, which is a first signal light, propagates and second optical waveguides 36a to 36d through which the output light L3, which is a second signal light different from the output light L2, propagates. The first optical waveguides 36e to 36h may be provided on the side 31b side other than the center of the multimode interferometer, and the second optical waveguides 36a to 36d may be provided on the side 31c side other than the center of the multimode interferometer. In this case, the temperatures of the first optical waveguides 36e to 36h located on the side 31b side and the temperatures of the second optical waveguides 36a to 36d located on the side 31c side can be allowed to be nearly uniform.

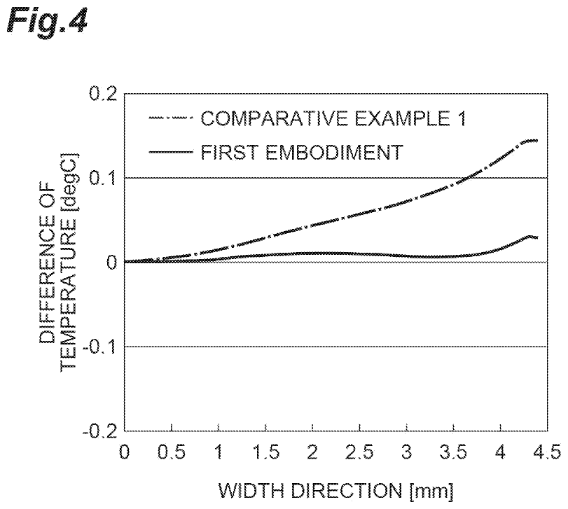

FIG. 4 is a graph illustrating the analysis result (the difference between the temperature distribution of the modulation element when the temperature of the optical module is 35° C. and the temperature distribution of the modulation element when the temperature of the optical module is 75° C.) of the temperature distribution of the modulation element in the optical module according to the first embodiment and the temperature distribution of the modulation element in the optical module according to Comparative Example 1. The optical module according to the first embodiment is the same as the optical module 1 described above. The optical module according to Comparative Example 1 is different from the optical module 1 in that the spacings between the two Peltier elements aligned along the width direction (second direction D2) are the same (the plurality of Peltier elements are uniformly arranged). The horizontal axis in FIG. 4 indicates the displacement in the width direction (X direction), and the vertical axis in FIG. 4 indicates the temperature difference on the line Z (see FIG. 3) extending in the X direction when the center of the end (the side 31b) the modulation element on the side opposite to the control terminal is set to 0. As illustrated in FIG. 4, in the optical module according to Comparative Example 1, the temperature is increased when approaching the control terminal side. On the other hand, in the optical module according to the first embodiment, the temperature rise is suppressed to 0.05° C. or less even when approaching the control terminal side, and it is understood that the temperature distribution can be allowed to be nearly uniform.

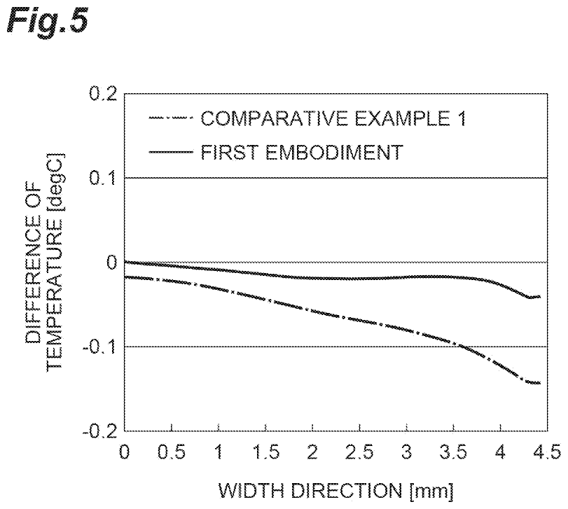

FIG. 5 is a graph illustrating the analysis result (the difference between the temperature distribution of the modulation element when the temperature of the optical module is 35° C. and the temperature distribution of the modulation element when the temperature of the optical module is −5° C.) of the temperature distribution of the modulation element in the optical module according to the first embodiment and the temperature distribution of the modulation element in the optical module according to Comparative Example 1. As illustrated in FIG. 5, in the optical module according to Comparative Example 1, the temperature is decreased when approaching the control terminal side. On the other hand, in the optical module according to the first embodiment, the temperature drop is suppressed to 0.05° C. or less even when approaching the control terminal side, and it is understood that the temperature distribution can be allowed to be nearly uniform.

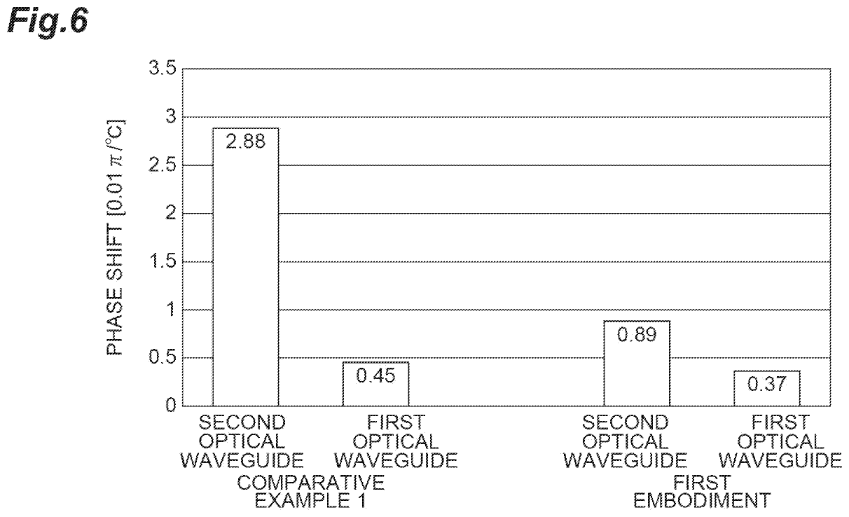

FIG. 6 is a graph illustrating the analysis result of the phase shifts of the first optical waveguide and the second optical waveguide in the optical module according to the first embodiment and the optical module according to Comparative Example 1, respectively. As illustrated in FIG. 6, in the optical module according to Comparative Example 1, the phase shift of 0.45 π/° C. occurs in the first optical waveguide, and the phase shift of 2.88 π/° C. occurs in the second optical waveguide. On the other hand, in the optical module according to the first embodiment, the phase shift of 0.37 π/° C. occurs in the first optical waveguide, and the phase shift of 0.89 π/° C. occurs in the second optical waveguide. Thus, in the first embodiment in which the arrangement of the Peltier elements is denser as the Peltier element approaches the control terminal, the phase shift can be suppressed compared to Comparative Example 1 in which the arrangement of the Peltier elements is uniform. In particular, it is understood that, in the optical module according to the first embodiment, the phase shift in the width direction can be remarkably suppressed.

Next, various modified examples of the optical module according to the present disclosure will be described. A portion of the configuration of the optical module according to various modified examples described later is the same as a portion of the configuration of the optical module 1 described above. Therefore, in the following description, the description overlapping with the description of the configuration of the optical module 1 will be omitted as appropriate with the same reference numerals denoted.

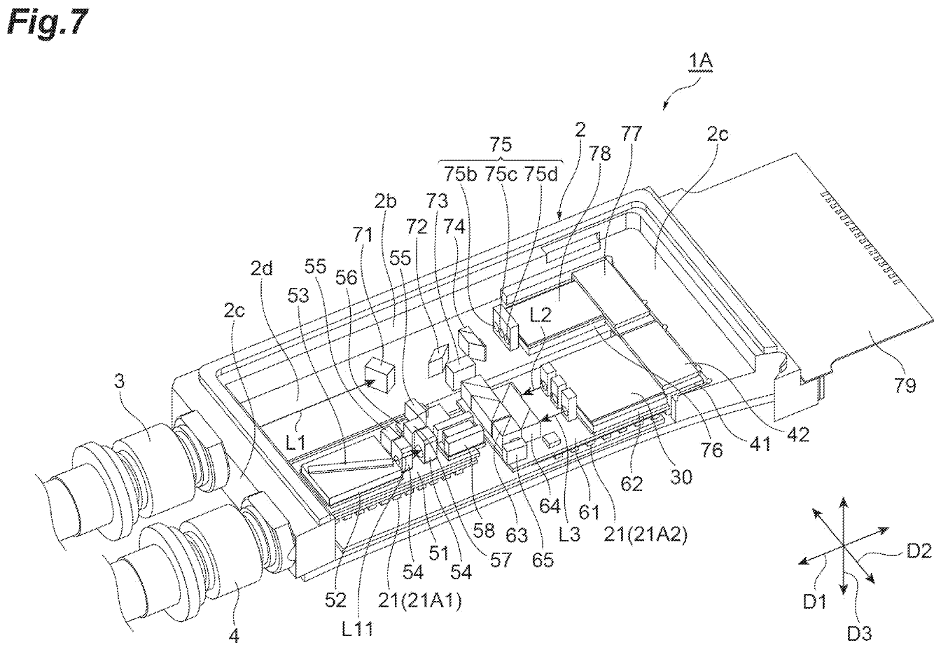

FIG. 7 is a perspective view illustrating an internal structure of an optical module 1A according to Modified Example 1. Since a portion of the configuration of the optical module 1A is the same as a portion of the configuration of the optical module 1 described above, the description overlapping with the description of the optical module 1 will be omitted as appropriate with the same reference numerals denoted. The optical module 1A has optical components different from those of the optical module 1. The optical module 1A has two temperature control devices 21, and the two temperature control devices 21 are aligned along the first direction D1. The two temperature control devices 21 are a first temperature control device 21A1 and a second temperature control device 21A2.

The optical module 1A includes a wavelength variable light source base 51 mounted on the first temperature control device 21A1, a wavelength variable light source carrier 52 mounted on the wavelength variable light source base 51, and a wavelength variable light source element 53 mounted on the wavelength variable light source carrier 52. Furthermore, the optical module 1A includes a plurality of lenses 54 mounted on the wavelength variable light source base 51, a plurality of wavelength control monitor elements 55, a thermistor 56, an etalon filter 57, and an isolator 58. A light L11 output from the wavelength variable light source element 53 is input to the plurality of lenses 54, and the light L11 passing through the plurality of lenses 54 is input to the isolator 58.

The optical module 1A includes a modulation element base 61 mounted on the second temperature control device 21A2 and a modulation element carrier 62 mounted on the modulation element base 61, and the above-described modulation element 30 is mounted on the modulation element carrier 62. The optical module 1A has the composite filter block 63 mounted on the modulation element base 61, a polarization synthesizing filter 64, and a light receiving element 65 for monitoring the intensity of the modulated output light. The light L11 passing through the isolator 58 is input to the composite filter block 63 and the polarization synthesizing filter 64. In the polarization synthesizing filter 64, the output light L2 and the output light L3 are multiplexed to be incident on the composite filter block 63. A portion of the multiplexed output light L2 and output light L3 passes through the composite filter block 63 to be output to the outside of the optical module 1 from the output assembly 4 with the sleeve. The remainder of the multiplexed output light L2 and output light L3 is reflected by the composite filter block 63 and monitored by the light receiving element 65 for monitoring the intensity of the modulated output light.

The optical module 1A includes a first optical path adjusting filter 71, a mirror 72, a second optical path adjusting filter 73, a polarization separating filter 74, a lens 75 having a first lens unit 75b, a second lens unit 75c, and a third lens unit 75d, and a demodulation element carrier 76. The first optical path adjusting filter 71, the mirror 72, the second optical path adjusting filter 73, the polarization separating filter 74, the lens 75, and the demodulation element carrier 76 are mounted on the bottom wall 2d of the housing 2.

The optical module 1A includes a trans impedance amplifier (TIA) 77 mounted on the heat sink 41, a demodulation element 78 mounted on the demodulation element carrier 76, and a flexible printed circuit (FPC) 79 extending from the housing 2 to the side opposite to the input assembly 3 and the output assembly 4. The input light L1 input from the input assembly 3 into the optical module 1 passes through the first optical path adjusting filter 71 to be incident on the polarization separating filter 74.

A portion of the input light L1 reaching the polarization separating filter 74 passes through the polarization separating filter 74 to be input on the first lens unit 75b of the lens 75. The remaining portion of the input light L1 reaching the polarization separating filter 74 is reflected twice by the polarization separating filter 74 to be input on the third lens unit 75d of the lens 75. The light L11 is input from the composite filter block 63 to the second optical path adjusting filter 73 and the mirror 72 in the second direction D2. The light L11 is reflected by the mirror 72 in the first direction D1 to be input on the second lens unit 75c of the lens 75. The optical module 1A according to Modified Example 1 has been described above. This optical module 1A also provides the same functions and effects as those of the optical module 1 described above.

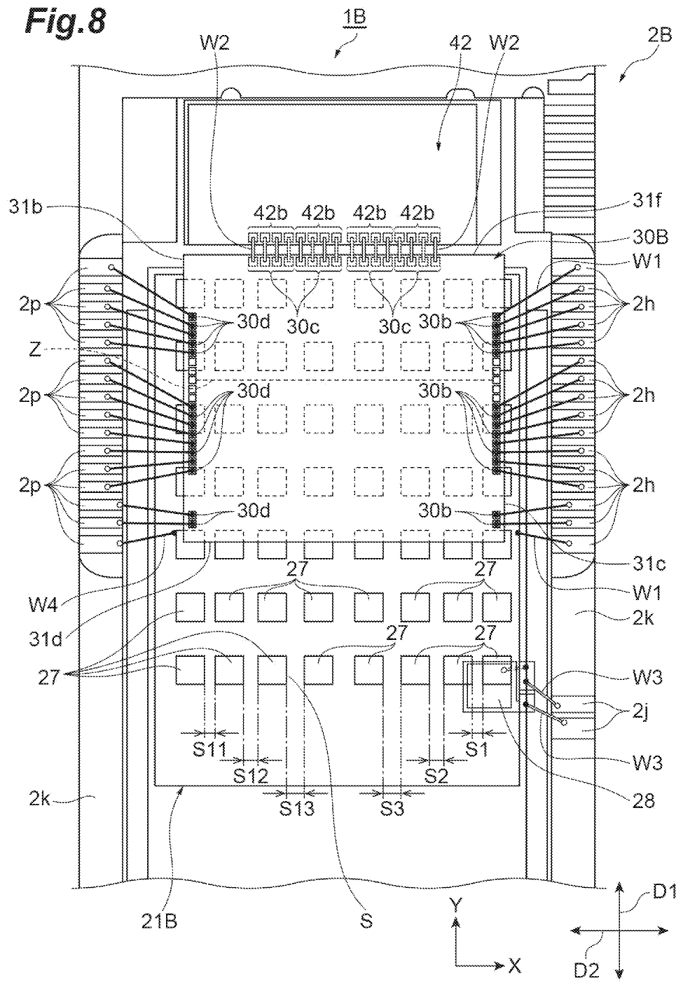

FIG. 8 is a plan view schematically illustrating a temperature control device 21B, a modulation element 30B, a driver IC 42, and a frame body 2k of a housing 2B of an optical module 1B according to Modified Example 2. As illustrated in FIG. 8, the optical module 1B further includes a wiring pattern 2p (second wiring pattern) provided on the frame body 2k of the housing 2B. The wiring pattern 2p is aligned along the first direction D1 the side opposite to the wiring pattern 2h when viewed from the modulation element 30B. The modulation element 30B further includes a control terminal (second bonding pad) 30d. The control terminals 30d are aligned along the first direction D1 on the side 31b (third side) side. The wiring pattern 2p is connected to the control terminal 30d of the modulation element 30B through a bonding wiring (second bonding wiring) W4.

The temperature control device 21B has the plurality of Peltier elements 27. The spacing S between the plurality of Peltier elements 27 located on the side 31b side (the control terminal 30d side of the modulation element 30B or the wiring pattern 2p side of the housing 2B) is narrower than the spacing S between the plurality of Peltier elements 27 located in the center of the modulation element 30B. That is, the plurality of Peltier elements 27 are densely arranged on the side 31b side compared to the center of the modulation element 30B.

For example, a spacing S11 between the Peltier element 27 located closest to the side 31b side and the Peltier element 27 located second closest to the side 31b side is narrower than a spacing S12 between the Peltier element 27 located second closest to the side 31b side and the Peltier element 27 located third closest to the side 31b side. The spacing S12 is narrower than a spacing S13 between the Peltier element 27 located third closest to the side 31b side and the Peltier element 27 located fourth closest to the side 31b side. As an example, the spacing S11 is 0.15 mm, the spacing S12 is 0.2 mm, and the spacing S13 is 0.25 mm

As described above, the optical module 1B according to Modified Example 2 includes the control terminal 30d arranged on the side 31b side of the modulation element 30B and the wiring pattern 2p provided on the frame body 2k of the housing 2B and connected to the control terminal 30d of the modulation element 30B through the bonding wiring W4. The spacing S between the plurality of Peltier elements 27 located on the side 31b side is narrower than the spacing between the plurality of Peltier elements 27 located in the center of the modulation element 30B. Since the control terminal 30d and the bonding wiring W4 are provided on the side 31b side, in the side 31b side, the heat inflow/outflow is likely to occur compared to the center of the modulation element 30B. In the optical module 1B, the spacing S between the plurality of Peltier elements 27 located on the side 31b side is narrower than the spacing S between the plurality of Peltier elements 27 located in the center of the modulation element 30B. Therefore, since the Peltier elements 27 are densely arranged on the side 31b side compared to the center of the modulation element 30B, the influence of the heat inflow/outflow on the side 31b side can be reduced. Therefore, the temperature distribution of the modulation element 30B can be allowed to be nearly uniform, and thus, the phase shift can be suppressed.

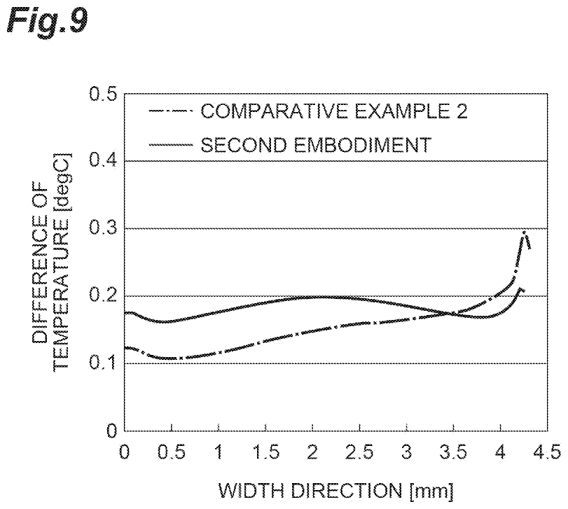

FIG. 9 is a graph illustrating the analysis result (the difference between the temperature distribution of the modulation element when the temperature of the optical module is 35° C. and the temperature distribution of the modulation element when the temperature of the optical module is 75° C.) of the temperature distribution of the modulation element in the optical module according to the second embodiment and the temperature distribution of the modulation element in the optical module according to Comparative Example 2. The optical module according to the second embodiment is the same as the optical module 1B described above. The optical module according to Comparative Example 2 is different from the optical module 1B in that the spacings between the two Peltier elements 27 aligned along the width direction (second direction D2) are the same (the plurality of Peltier elements are uniformly arranged). The horizontal axis of FIG. 9 indicates the displacement in the width direction, and the vertical axis of FIG. 9 indicates the temperature difference on the line Z (see FIG. 8) extending in the X direction when the center of the side 31b of the modulation element is set to 0. As illustrated in FIG. 9, in the optical module according to the second embodiment, compared to Comparative Example 2, it is understood that the temperature change is suppressed to 0.05° C. or less in the X direction, and thus, the temperature distribution can be allowed to be nearly uniform.

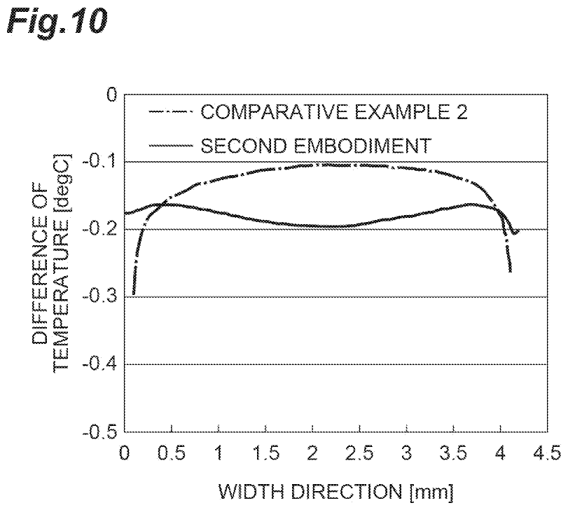

FIG. 10 is a graph illustrating the analysis result (the difference between the temperature distribution of the modulation element when the temperature of the optical module is 35° C. and the temperature distribution of the modulation element when the temperature of the optical module is −5° C.) of the temperature distribution of the modulation element in the optical module according to the second embodiment and the temperature distribution of the modulation element in the optical module according to Comparative Example 2. As illustrated in FIG. 10, in the optical module according to the second embodiment, compared to Comparative Example 2, it is understood that the temperature change is suppressed to 0.05° C. or less in the X direction, and thus, the temperature distribution can be allowed to be nearly uniform.

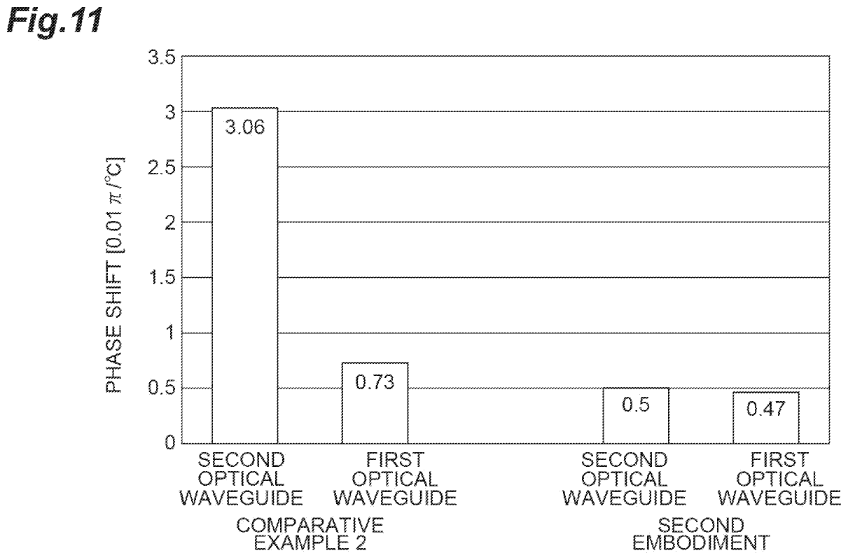

FIG. 11 is a graph illustrating analysis result of the phase shifts of the first optical waveguide and the second optical waveguide in the optical module according to the second embodiment and the optical module according to Comparative Example 2, respectively. As illustrated in FIG. 11, in the optical module according to Comparative Example 2, the phase shift of 0.73 π/° C. occurs in the first optical waveguide, and the phase shift of 3.06 π/° C. occurs in the second optical waveguide. On the other hand, in the optical module according to the second embodiment, the phase shift of 0.47 π/° C. occurs in the first optical waveguide, and the phase shift of 0.5 π/° C. occurs in the second optical waveguide. Thus, in the second embodiment in which the arrangement of the Peltier elements is denser as the Peltier element approaches the control terminal 30d, the phase shift can be suppressed compared to Comparative Example 2 in which the arrangement of the Peltier elements is uniform. In particular, it is understood that, in the optical module according to the second embodiment, the phase shift in the width direction can be significantly suppressed.

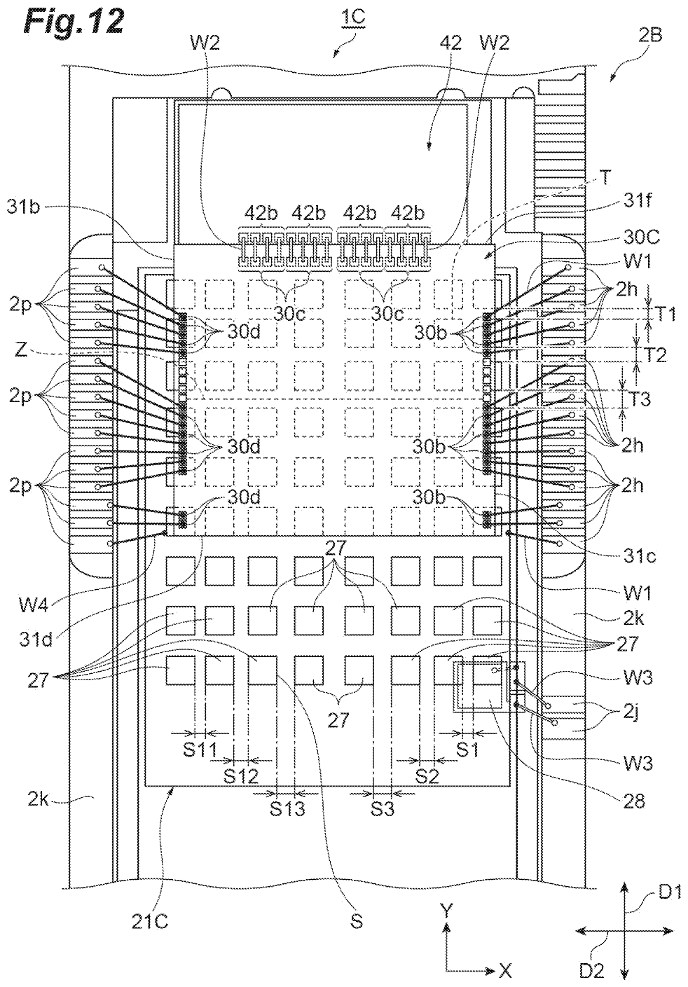

FIG. 12 is a plan view schematically illustrating a temperature control device 21C, the modulation element 30C, the driver IC 42, and the frame body 2k of the housing 2B of an optical module 1C according to Modified Example 3. The driver IC 42 is a heating element. As illustrated in FIG. 12, in the optical module 1C, the temperature control device 21C has the plurality of Peltier elements 27. A spacing T between two Peltier elements 27 aligned along the first direction D1 varies depending on the position of the Peltier elements 27 in the first direction D1. The spacing T between the plurality of Peltier elements 27 located on the side 31f side (on the electrode pad 30c side of the modulation element 30C or on the driver IC 42 side which is the driving circuit) which is the first side is narrower than the spacing T between the plurality of Peltier elements 27 located in the center of the modulation element 30C. That is, the plurality of Peltier elements 27 are densely arranged on the side 31f side compared to the center of the modulation element 30C.

For example, a spacing T1 between the Peltier element 27 located closest to the side 31f side and the Peltier element 27 located second closest to the side 31f side is narrower than a spacing T2 between the Peltier element 27 located second closest to the side 31f side and the Peltier element 27 located third closest to the side 31f side. The spacing T2 is narrower than a spacing T3 between the Peltier element 27 located third closest to the side 31f side and the Peltier element 27 located fourth closest to the side 31f side. As an example, the spacing T1 is 0.15 mm, the spacing T2 is 0.2 mm, and the spacing T3 is 0.25 mm.

The optical module 1C includes the bonding wiring W2 arranged on the side 31f side of the modulation element 30C and the electrode pad 42b provided on the driver IC 42 and connected to the electrode pad 30c (third bonding pad) of the modulation element 30C through the bonding wiring W2 (third bonding wiring). The spacing T between the plurality of Peltier elements 27 located on the side 31f side is narrower than the spacing T between the plurality of Peltier elements 27 located in the center of the modulation element 30C. Since the electrode pad 30c and the bonding wiring W2 are provided on the side 31f side, in the side 31f side, the heat inflow/outflow is likely to occur compared to the center of the modulation element 30C. In the optical module 1C, the spacing T between the plurality of Peltier elements 27 located on the side 31f side is narrower than the spacing T between the plurality of Peltier elements 27 located in the center of the modulation element 30C. Therefore, since the Peltier elements 27 are densely arranged on the side 31f side compared to the center of the modulation element 30C, the influence of the heat inflow/outflow on the side 31f side can be reduced. Therefore, the temperature distribution of the modulation element 30C can be allowed to be nearly uniform, and thus, the phase shift can be suppressed.

In the optical module 1C, the driver IC 42, which is the driving circuit, is a heating element, and the driver IC 42 is arranged on the side 31f side of the modulation element 30C. In the optical module 1C, as described above, the Peltier elements 27 are densely arranged on the side 31f side of the modulation element 30C where the driver IC 42 is arranged. Therefore, since the influence of the heat inflow/outflow from the driver IC 42, which is a heating element, can be reduced, the temperature distribution of the modulation element 30C can be allowed to be nearly uniform, and thus, the phase shift can be suppressed.

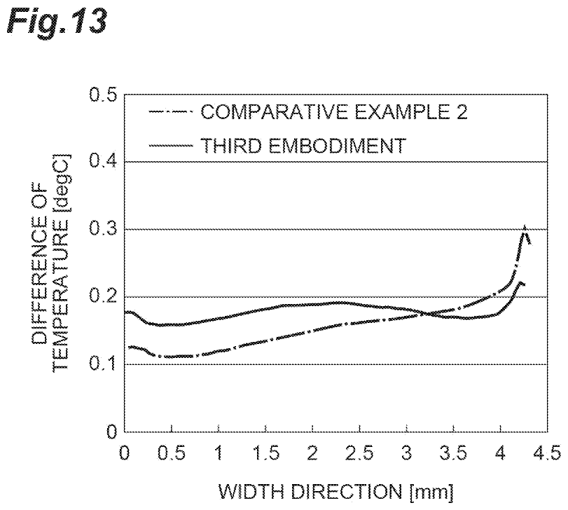

FIG. 13 is a graph illustrating the analysis result (the difference between the temperature distribution of the modulation element when the temperature of the optical module is 35° C. and the temperature distribution of the modulation element when the temperature of the optical module is 75° C.) of the temperature distribution of the modulation element in the optical module according to the third embodiment and the temperature distribution of the modulation element in the optical module according to Comparative Example 2. The optical module according to the third embodiment is the same as the optical module 1C described above. The horizontal axis of FIG. 13 indicates the displacement in the width direction, and the vertical axis of FIG. 13 indicates the temperature difference on the line Z (see FIG. 12) extending in the X direction when the center of the side 31b of the modulation element is set to 0. As illustrated in FIG. 13, in the optical module according to the third embodiment, compared to Comparative Example 2, it is understood that the temperature change is suppressed to 0.05° C. or less even when separated from the side 31b, and thus, the temperature distribution can be allowed to be nearly uniform.

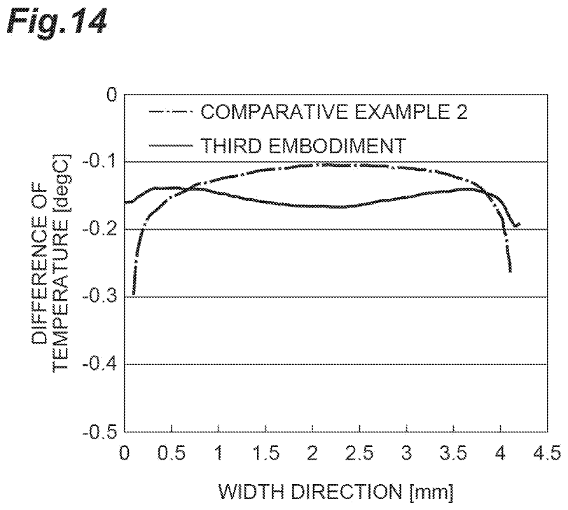

FIG. 14 is a graph illustrating the analysis result (the difference between the temperature distribution of the modulation element when the temperature of the optical module is 35° C. and the temperature distribution of the modulation element when the temperature of the optical module is −5° C.) of the temperature distribution of the modulation element in the optical module according to the third embodiment and the temperature distribution of the modulation element in the optical module according to Comparative Example 2. As illustrated in FIG. 14, in the optical module according to the third embodiment, compared to Comparative Example 2, it is understood that the temperature change in the X direction is suppressed to 0.05° C. or less, and thus, the temperature distribution can be allowed to be nearly uniform.

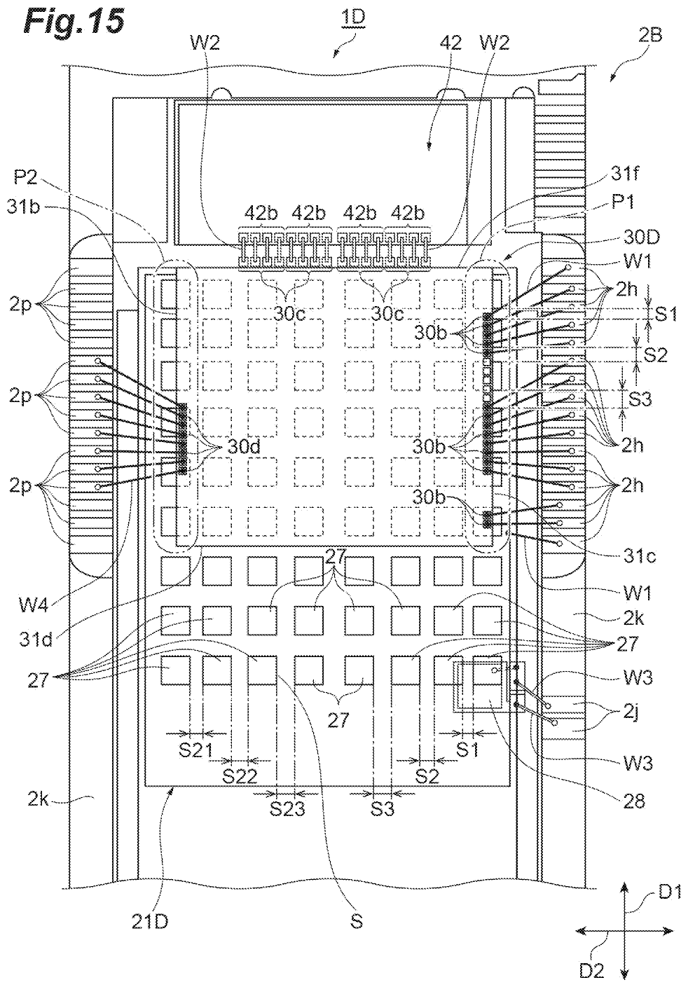

FIG. 15 is a plan view schematically illustrating a temperature control device 21D, the modulation element 30D, the driver IC 42, and the frame body 2k of the housing 2B of an optical module 1D according to Modified Example 4. The number of bonding wirings W4 in the optical module 1D is different from the number of bonding wirings W4 in the afore-mentioned optical module 1B. The optical module 1D includes a first heat capacity portion P1 located around the modulation element 30D and a second heat capacity portion P2 located around the modulation element 30D and at the location where the second heat capacity portion P2 is different from the first heat capacity portion P1.

The first heat capacity portion P1 is located on the side 31c side when viewed from the modulation element 30D. The first heat capacity portion P1 includes the control terminal 30b arranged on the side 31c side of the modulation element 30D, the bonding wiring W1, and the wiring pattern 2h. The second heat capacity portion P2 is located on the side 31b side when viewed from the modulation element 30D. The second heat capacity portion P2 includes the control terminal 30d arranged on the side 31b side of the modulation element 30D, the bonding wiring W4, and the wiring pattern 2p. The number of bonding wirings W1 is larger than the number of bonding wirings W4. Therefore, the heat capacity in the first heat capacity portion P1 is larger than the heat capacity in the second heat capacity portion P2. That is, the heat inflow/outflow from the first heat capacity portion P1 to the modulation element 30D is larger than the heat inflow/outflow from the second heat capacity portion P2 to the modulation element 30D.

In the temperature control device 21D, the spacing S between the two Peltier elements 27 aligned along the second direction D2 varies depending on the positions of the Peltier elements 27 in the second direction D2. The spacing S between the Peltier elements 27 located on the first heat capacity portion P1 side (the side 31c side) is narrower than the spacing S between the Peltier elements 27 located on the second heat capacity portion P2 side (the side 31b side). That is, the Peltier elements 27 are densely arranged on the first heat capacity portion P1 side compared to the second heat capacity portion P2 side.

For example, the spacing S1 between the Peltier element 27 located closest to the side 31c side and the Peltier element 27 located second closest to the side 31c side is narrower than a spacing S21 between the Peltier element 27 located closest to the side 31b side and the Peltier element 27 located second closest to the side 31b side. For example, the spacing S2 between the Peltier element 27 located second closest to the side 31c side and the Peltier element 27 located third closest to the side 31c side is narrower than a spacing S22 between the Peltier element 27 located second closest to the side 31b side and the Peltier element 27 located third closest to the side 31b side. For example, the spacing S3 between the Peltier element 27 located third closest to the side 31c side and the Peltier element 27 located fourth closest to the side 31c side is the same as a spacing S23 between the Peltier element 27 located third closest to the side 31b side and the Peltier element 27 located fourth closest to the side 31b side. As an example, the spacing S1 is 0.15 mm, the spacing S21 is 0.18 mm, the spacing S2 is 0.2 mm, the spacing S22 is 0.23 mm, and the spacings S3 and S23 are 0.25 mm.

In the optical module 1D, the modulation element 30D is mounted on the temperature control device 21D, and the modulation element 30D and the temperature control device 21D are accommodated in the housing 2B. The modulation element 30D has the side 31b and the side 31c facing the side 31b. The first heat capacity portion P1 and the second heat capacity portion P2 located at the different location from the first heat capacity portion P1 are arranged around the modulation element 30D. The heat capacity in the first heat capacity portion P1 is larger than the heat capacity in the second heat capacity portion P2. Therefore, the heat inflow/outflow of the modulation element 30D in the first heat capacity portion P1 is likely to occur compared to the second heat capacity portion P2. In the optical module 1D, the plurality of Peltier elements 27 are arranged with spacings in the temperature control device 21D, and the spacing S between the plurality of Peltier elements 27 located on the first heat capacity portion P1 side is narrower than the spacing S between the plurality of Peltier elements 27 located on the second heat capacity portion P2 side. Therefore, since the Peltier elements 27 are densely arranged on the first heat capacity portion P1 side compared to the second heat capacity portion P2 side, the influence of the heat inflow/outflow of the first heat capacity portion P1 side can be reduced. Therefore, the temperature distribution of the modulation element 30D can be allowed to be nearly uniform, and thus, the phase shift can be suppressed.

The embodiments and various modified examples of the optical module according to the present disclosure have been described above. However, the invention is not limited to the embodiments or modified examples described above. That is, it will be readily recognized by those skilled in the art that the present invention can be changed and modified in various ways without departing from the scope of the claims. For example, the shape, size, number, material, and layout of each component of the optical module are not limited to those described above and can be changed as appropriate.

What is claimed is:

1. An optical module comprising:
an optical element having a first side, a second side intersecting the first side, and a third side facing the second side;
a housing accommodating the optical element;
a thermoelectric cooler mounted inside the housing and with the optical element being mounted on the thermoelectric cooler;
a driving circuit arranged on the side of the first side of the optical element;
a first bonding pad arranged on the side of the second side of the optical element; and
a first wiring pattern provided on the frame body of the housing and connected to the first bonding pad of the optical element through the first bonding wiring,
wherein the thermoelectric cooler has a plurality of Peltier elements arranged with spacings, and
wherein a spacing between the plurality of Peltier elements located on the side of the second side is narrower than a spacing between the plurality of Peltier elements located in the center of the optical element.

2. The optical module according to claim 1,
wherein the optical element is a multimode interferometer having a first optical waveguide with a first signal light propagating in the first optical waveguide and a second optical waveguide with a second signal light different from the first signal light propagating in the second optical waveguide,
wherein the first optical waveguide is provided closer to the side of the second side than the center of the multimode interferometer, and
wherein the second optical waveguide is provided closer to the side of the third side than the center of the multimode interferometer.

3. The optical module according to claim 1, further comprising:
a second bonding pad arranged on the side of the third side of the optical element; and
a second wiring pattern provided on the frame body of the housing and connected to the second bonding pad of the optical element through the second bonding wiring,
wherein a spacing between the plurality of Peltier elements located on the side of the third side is narrower than the spacing between the plurality of Peltier elements located in the center of the optical element.

4. The optical module according to claim 1, further comprising:
a third bonding pad arranged on the side of the first side of the optical element; and
a third wiring pattern provided in the driving circuit and connected to the third bonding pad of the optical element through a third bonding wiring,
wherein a spacing between the plurality of Peltier elements located on the side of the first side is narrower than the spacing between the plurality of Peltier elements located in the center of the optical element.

5. The optical module according to claim 4,
wherein the driving circuit is a heating element.

6. An optical module comprising:
an optical element having a first side, a second side intersecting the first side, and a third side facing the second side;
a housing accommodating the optical element;
a thermoelectric cooler disposed inside the housing, with the optical element being mounted on the thermoelectric cooler;
a first heat capacity portion located around the optical element; and
a second heat capacity portion located around the optical element and at a position different from the first heat capacity portion,
wherein heat capacity of the first heat capacity portion is larger than heat capacity of the second heat capacity portion,
wherein the thermoelectric cooler has a plurality of Peltier elements arranged with spacings, and
wherein a spacing between the plurality of Peltier elements located on the first heat capacity portion side is narrower than a spacing between the plurality of Peltier elements located on the second heat capacity portion side.
